(19) United States
(12) Patent Application Publication
(10) Pub. No.: US 2025/0023310 A1
(43) Pub. Date: Jan. 16, 2025

(54) CHARGING CONTACT WITH SHUNTLESS BRUSH

(71) Applicant: Conductix, Inc., Omaha, NE (US)

(72) Inventors: Joel Sherburne, Omaha, NE (US); Martin Blair, Gretna, NE (US); John M. Becker, Omaha, NE (US); Jonathon D. Smith, Kalamazoo, MI (US)

(21) Appl. No.: 18/771,317

(22) Filed: Jul. 12, 2024

Related U.S. Application Data
(60) Provisional application No. 63/513,481, filed on Jul. 13, 2023.

(51) Int. Cl. H01R 41/02; H01R 4/48

(52) U.S. Cl. CPC H01R 41/02; H01R 4/48

(57) ABSTRACT

A charging contact assembly can include a brush for configured to translate in a first direction generally perpendicular to a second direction of travel of the charging contact assembly. The brush can include a first contact surface for contacting the conducting surface, and a second contact surface parallel to the first direction of translation of the brush and perpendicular to the second direction of travel of the charging contact assembly. The charging contact assembly can also include a connector having a connection for connecting to a source of electrical energy, and a connector contact surface electrically coupled with the connection and arranged parallel to the second contact surface of the brush to contact the second contact surface of the brush. The charging contact assembly can further include a biasing mechanism for biasing the connector contact surface of the connector into contact with the second contact surface of the brush.

### CROSS-REFERENCE TO RELATED APPLICATIONS

The present application claims the benefit under 35 U.S.C. § 119(e) of U.S. Provisional Application Ser. No. 63/513,481, filed Jul. 13, 2023, and titled “CHARGING CONTACT WITH SHUNTLESS BRUSH,” which is herein incorporated by reference in its entirety.

### BACKGROUND

A charging contact is a contact-based electrical connector designed to connect a power source to mobile equipment through brush or plate contact. Charging contacts are equipped with a set of contact pins, plates, or surfaces configured to mate with a corresponding set of pins, plates, or surfaces on the equipment.

### DRAWINGS

The Detailed Description is described with reference to the accompanying figures. The use of the same reference numbers in different instances in the description and the figures may indicate similar or identical items.

FIG. 1 is a perspective view illustrating a brush configured to contact a conducting surface to transfer electrical current, where the brush has a shunt or wire connected thereto.

FIG. 2 is a perspective view illustrating two brushes, such as the brush shown in FIG. 1, where each of the two brushes has a shunt or wire connected thereto.

FIG. 3 is a perspective view illustrating a charging contact assembly in accordance with example embodiments of the present disclosure.

FIG. 4 is an exploded perspective view of the charging contact assembly illustrated in FIG. 3.

FIG. 5 is a perspective view illustrating a charging contact assembly in accordance with example embodiments of the present disclosure.

FIG. 6 is a partial cross-sectional perspective view of the charging contact assembly illustrated in FIG. 5.

FIG. 7 is an exploded perspective view of the charging contact assembly illustrated in FIG. 5.

FIG. 8 is a perspective view illustrating a brush and a set of curved connectors for a charging contact assembly in accordance with an example embodiment of the present disclosure.

FIG. 9 is a partial cross-sectional side elevation view of the brush and the set of curved connectors illustrated in FIG. 8 disposed within a housing of a charging contact assembly in accordance with an example embodiment of the present disclosure.

FIG. 10 is a partial cross-sectional side elevation view illustrating a brush having a set of concave surfaces for receiving a set of curved connector surfaces disposed within a housing of a charging contact assembly in accordance with an example embodiment of the present disclosure.

FIG. 11 is a perspective view illustrating a brush and a set of connectors each having a set of curved fingers for a charging contact assembly in accordance with an example embodiment of the present disclosure.

FIG. 12 is a partial cross-sectional side elevation view of the brush and the set of connectors illustrated in FIG. 11 arranged within a housing of the charging contact assembly in accordance with an example embodiment of the present disclosure.

FIG. 13 is a partial cross-sectional side elevation illustrating a brush and a set of springs coupled to an electrical connector for a charging contact assembly in accordance with an example embodiment of the present disclosure.

FIG. 14 is a partially exploded perspective view illustrating a brush and a set of spring-biased hinge plate connectors for a charging contact assembly in accordance with an example embodiment of the present disclosure.

FIG. 15 is a partial cross-sectional perspective view illustrating a brush and a set of spring-biased hinge plate connectors for a charging contact assembly in accordance with an example embodiment of the present disclosure.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

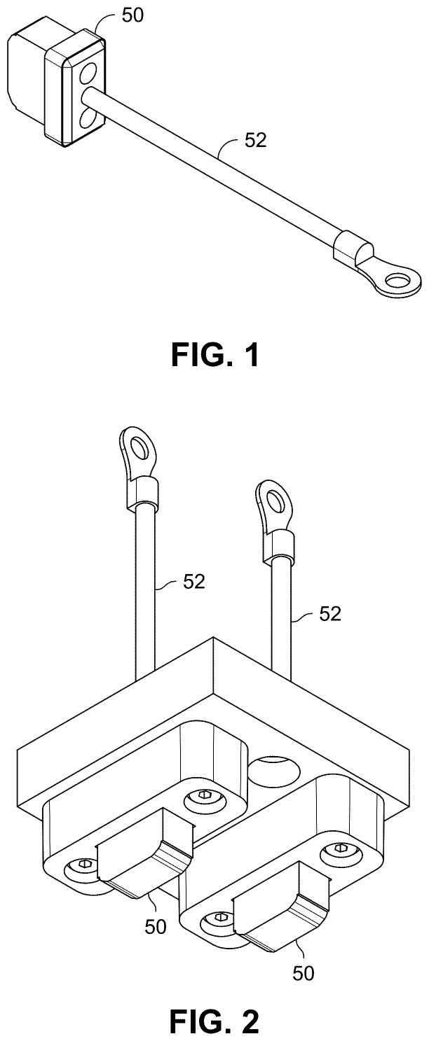

A charging base can be used for charging a battery-powered vehicle such that the vehicle mounts the charging base to charge and then dismounts the charging base after charging its battery. For example, a charging base can be generally ramp-shaped, and a vehicle can have one or more contacts that are guided by the ramp shape of the charging base into contact with one or more battery charging contacts or charging brushes. The brushes can be connected to a power source, such as a supply of electrical energy. Generally, one or more charging brushes on a battery-powered vehicle are displaced (e.g., towards or away from the vehicle) when mounting and dismounting a charging base. With reference to FIGS. 1 and 2, a brush 50 typically includes a shunt or wire 52, which can be molded into the brush, e.g., when the brush is manufactured. With this type of battery charging contact collector configuration, the brush 50 and wire 52 move up and down together with each cycle (e.g., as a vehicle drives onto and off of a charging base). This repeated motion fatigues the shunt with each cycle, eventually leading to shunt failure.

In general, it should be appreciated that the various embodiments of charging contact assemblies described herein may be arranged to deliver power to or receive power from a conducting surface. For example, in a first arrangement, a charging contact assembly is coupled with a power source, and a conducting surface is coupled with a battery-powered vehicle. In this arrangement, the charging contact assembly delivers power to the conducting surface while the charging contact assembly is in electrical communication with the conducting surface. In a second arrangement of power delivery from a power source to a battery-powered vehicle, a charging contact assembly is coupled with a battery-powered vehicle, and a conducting surface is coupled with a power source. In this arrangement, the charging contact assembly receives electrical power from the conducting surface while the charging contact assembly is in electrical communication with the conducting surface.

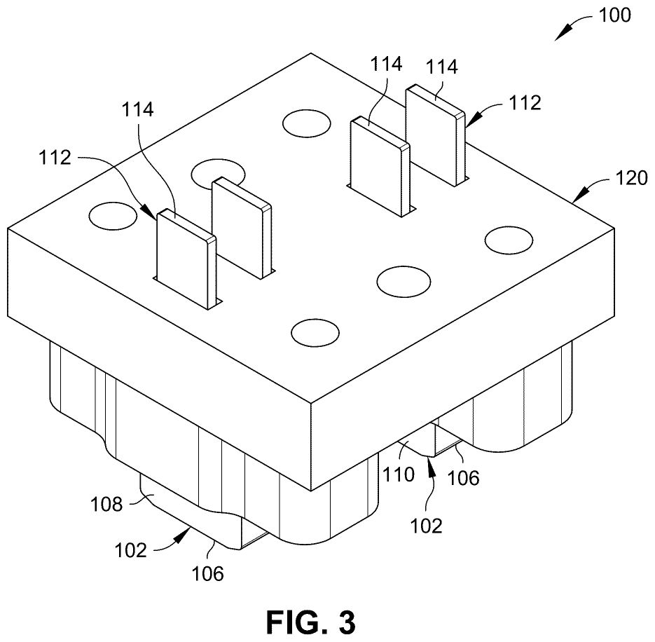

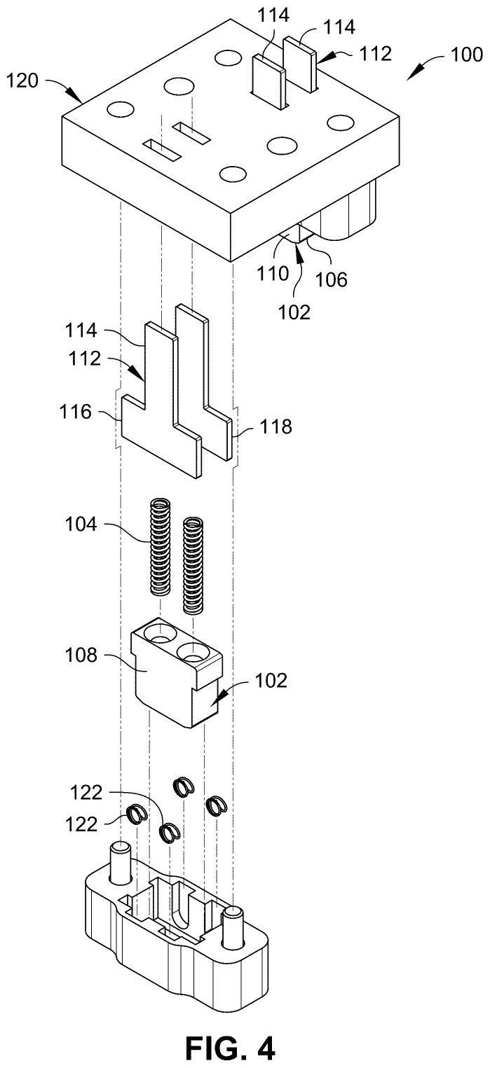

Referring now to FIGS. 3 and 4, charging contact assemblies 100 are described in accordance with example embodiments of the present disclosure. A charging contact assembly 100 includes a brush 102 for contacting a conducting surface to establish an electrical connection for carrying an electrical current through the conducting surface and the brush 102. In some embodiments, the brush 102 is made from a conducting material such as copper graphite. However, copper graphite is provided by way of example and is not meant to limit the present disclosure. A brush 102 can also be made from other conducting materials, such as a beryllium copper material. The conductive surface is configured to translate with respect to the charging contact assembly 100 (e.g., in a horizontal direction). As described, the brush 102 is configured to translate in another direction, i.e., generally perpendicular to the relative travel direction between the conductive surface and the charging contact assembly 100 (e.g., in a vertical direction). In some embodiments, the brush 102 can be biased in a direction toward the conducting surface, e.g., by one or more springs (e.g., coil springs 104) or other biasing members.

The brush 102 has a first contact surface 106 for contacting a conducting surface (e.g., the contact of a battery-powered vehicle or another contact) to carry the electrical current through the conducting surface and the brush 102. Rather than relying on a shunt or wire, such as the shunt or wire 52 described with reference to FIGS. 1 and 2, the brush 102 does not have a shunt or wire. Instead, the brush 102 has a second contact surface 108 arranged along a plane generally parallel to the direction of translation of the brush 102 with respect to the conducting surface and generally parallel to the relative travel direction between the charging contact assembly 100 and the conducting surface. In some embodiments, the brush 102 may also have one or more additional contact surfaces. For example, the brush 102 can have a third contact surface 110 opposite from the second contact surface 108 and arranged along another plane generally parallel to the direction of translation of the brush 102 with respect to the conducting surface and generally parallel to the travel direction of the charging contact assembly 100 with respect to the conducting surface.

The charging contact assembly 100 also includes a connector 112 to connect to an electrical device (e.g., a power source, such as AC mains, a battery, etc.) for receiving or delivering electrical current and conducting the electrical current to and/or from the brush 102. For instance, the connector 112 includes one or more connections 114 for connecting to the source of electrical energy and a connector contact surface 116 electrically coupled with the connection 114 and arranged generally parallel to the second contact surface 108 of the brush 102 to slidingly contact the second contact surface 108 of the brush 102. In embodiments of the disclosure, the second contact surface 108 (and possibly the third contact surface 110) of the brush 102 are smooth, conducting side surfaces, and the connector contact surface 116 (and possibly a second connector contact surface 118 of another connector 112) are conducting plates (e.g., copper plates) on either side of the brush 102.

The second contact surface 108 and possibly the third contact surface 110 of the brush 102 slidingly contact the connector contact surface 116 and possibly the second connector contact surface 118 of the connector(s) 112 for carrying the electrical current through the connector(s) 112 and the brush 102. In some embodiments, motion of the brush 102 with respect to a connector 112 can be constrained by a housing 120 and/or one or more other support structures for controlling the motion of the brush 102 with respect to the connector 112. In some embodiments, the housing 120 can be used as the biasing mechanism, e.g., forcing the contact surface(s) of the brush 102 into contact with the connector contact surface(s) of the connector 112 (e.g., without the use of a spring).

As described, the charging contact assembly 100 includes one or more biasing mechanisms (e.g., one or more springs 122) for biasing the connector contact surface 116 (and possibly the second connector contact surface 118) of the connector(s) 112 into contact with the second contact surface 108 (and possibly the third contact surface 110) of the brush 102. For example, one or more first springs 122 are disposed between the connector contact surface 116 and the housing 120 (e.g., brush holder that is coupled to the housing 120 or similar structure thereof), and one or more second springs are disposed between the second connector contact surface 118 and the housing 120 (e.g., brush holder that is coupled to the housing 120 or similar structure thereof). In this manner, the connector contact surface(s) can be biased (e.g., spring-loaded) to apply constant static pressure between the brush 102 and plates of the connector 112. In some embodiments, the copper contact connection plates of the connector 112 can have a shunt (not shown) soldered thereto, providing continuity to an electrical device (e.g., a power source, such as AC mains, a battery, etc.). With the shuntless brush arrangement described herein, only the brush 102 moves with each cycle, while the shunt remains static, which can reduce or eliminate the fatigue on the shunt.

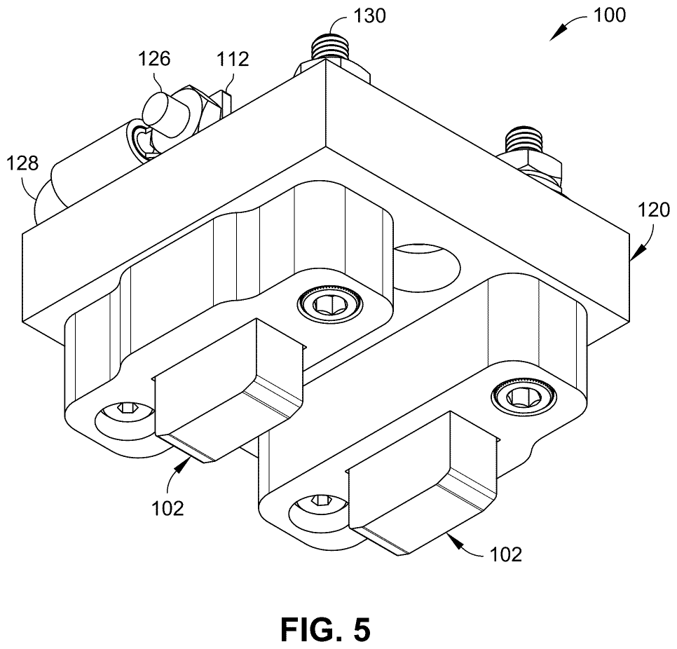

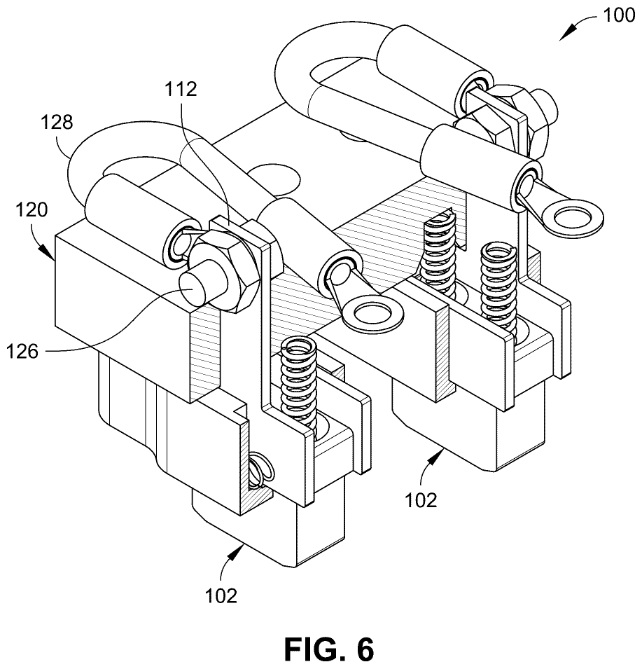

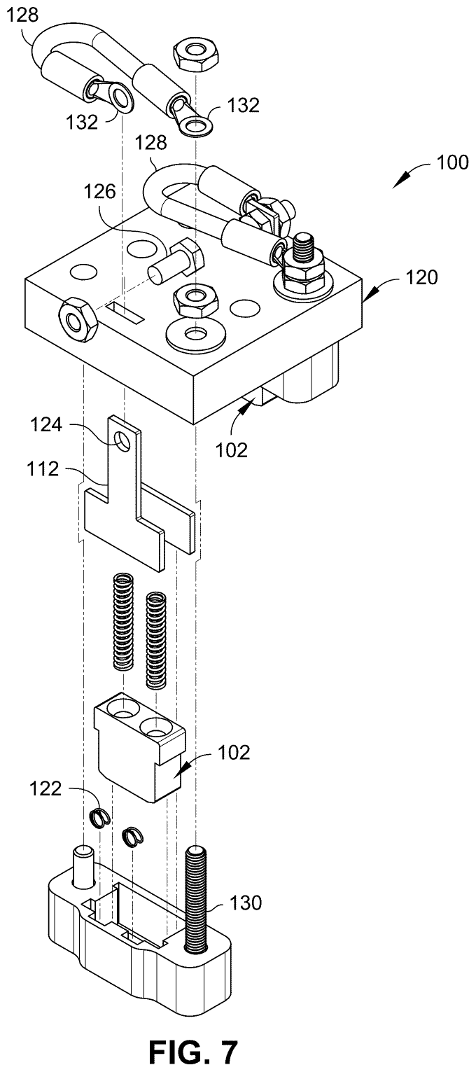

With reference to FIGS. 5 through 7, a charging contact assembly 100 has a connector 112 that includes a hole 124 for receiving a terminal fastener 126. In this embodiment, the terminal fastener 126 serves as a point of connection for receiving a connection, including, but not necessarily limited to: a ring terminal, a spade terminal, or a lug terminal of a shunt (not shown) for providing electrical continuity to an electrical device.

In an embodiment, charging contact assembly 100 includes a terminal shunt 128 that provides electrical continuity between the connector 112 and a terminal fastener 130. In this embodiment, the terminal shunt 128 includes corresponding terminals 132 (e.g., ring, spade, lug, etc.) located at respective ends of the terminal shunt 128 for receiving respective terminal fasteners 126 and 130, thus providing electrical continuity between the connector 112 and the terminal fastener 130. Terminal fastener 130 further serves as a point of connection for receiving a connection, including, but not necessarily limited to: a ring terminal, a spade terminal, or a lug terminal of a shunt (not shown) for providing electrical continuity to an electrical device. In some embodiments, housing 120 includes one or more holes for receiving respective one or more terminal fasteners 130. In some embodiments, a charging contact assembly 100 may include only a single spring-biased connector 112 for a brush 102.

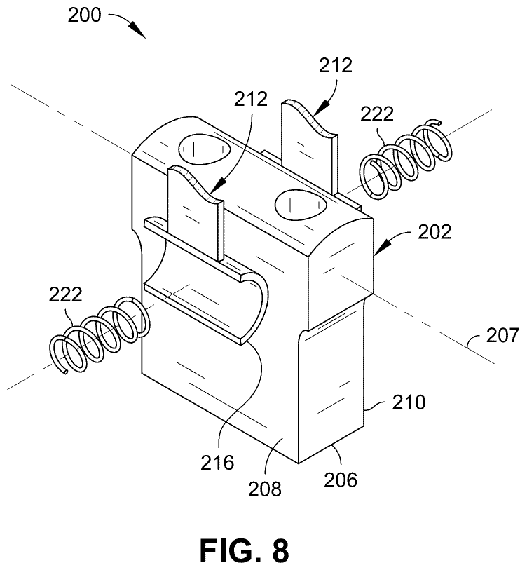

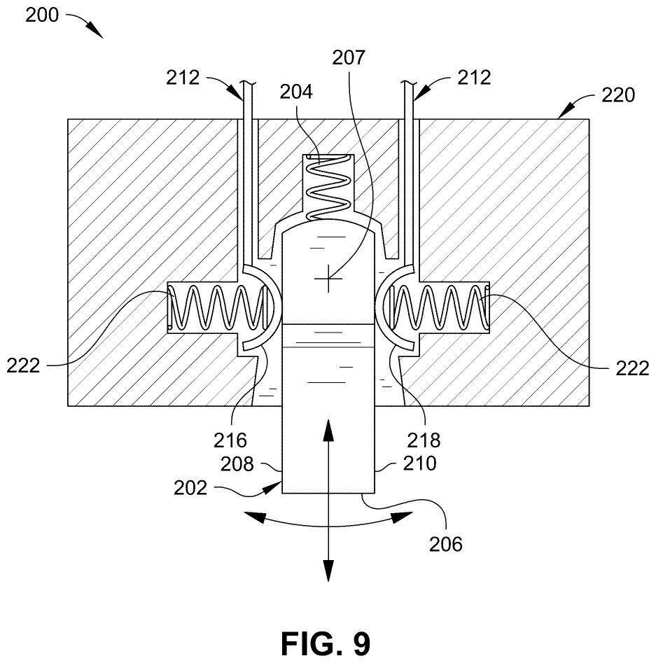

Referring now to FIGS. 8 and 9, charging contact assemblies 200 are described in accordance with example embodiments of the present disclosure. A charging contact assembly 200 includes a brush 202 for contacting a conducting surface to establish an electrical connection for carrying an electrical current through the conducting surface and the brush 202. In some embodiments, the brush 202 is made from a conducting material such as copper graphite, beryllium copper, etc. The conductive surface is configured to translate with respect to the charging contact assembly 200 (e.g., in a horizontal direction). As described, the brush 202 is configured to translate in another direction, i.e., generally perpendicular to the relative travel direction between the conductive surface and the charging contact assembly 200 (e.g., in a vertical direction). In some embodiments, the brush 202 can be biased in a direction toward the conducting surface, e.g., by one or more springs (e.g., coil springs 204) or other biasing members. In some embodiments, the brush 202 is configured to pivot about an axis 207 that extends generally parallel to the relative travel direction between the charging contact assembly 200 and the conducting surface (e.g, in the horizontal direction).

The brush 202 has a first contact surface 206 for contacting a conducting surface (e.g., the contact of a battery-powered vehicle or another contact) to carry the electrical current through the conducting surface and the brush 202. Rather than relying on a shunt or wire, such as the shunt or wire 52 described with reference to FIGS. 1 and 2, the brush 202 does not have a shunt or wire. Instead, the brush 202 has a second contact surface 208 arranged along a plane generally parallel to the direction of translation of the brush 202 with respect to the conducting surface and generally parallel to the relative travel direction between the charging contact assembly 200 and the conducting surface. In some embodiments, the brush 202 may also have one or more additional contact surfaces. For example, the brush 202 can have a third contact surface 210 opposite from the second contact surface 208 and arranged along another plane generally parallel to the direction of translation of the brush 202 with respect to the conducting surface and generally parallel to the travel direction of the charging contact assembly 200 with respect to the conducting surface.

The charging contact assembly 200 also includes a connector 212 to connect to an electrical device (e.g., a power source, such as AC mains, a battery, etc.) for receiving or delivering electrical current and conducting the electrical current to and/or from the brush 202. For instance, the connector 212 includes one or more connections (not shown) for connecting to the source of electrical energy and a connector contact surface 216 electrically coupled with the connection. The connector contact surface 216 (and possibly a second connector contact surface 218 of another connector) is configured to slidingly contact the second contact surface 208 of the brush 202 (and possibly the third contact surface 210 of the brush 202). In embodiments, the connector contact surfaces 216 and/or 218 can be a curved contact surface, such that the contact between the connector contact surfaces 216 and/or 218 and the respective contact surfaces 208 and/or 210 on the brush 202 form a line or lines of contact. In embodiments of the disclosure, the second contact surface 208 (and possibly the third contact surface 210) of the brush 202 are smooth, conducting side surfaces, and the connector contact surface 216 (and possibly the second connector contact surface 218) includes at least a curved portion of a conducting plate (e.g., a copper plate) on either side of the brush 202.

The second contact surface 208 and possibly the third contact surface 210 of the brush 202 slidingly contact the connector contact surface 216 and possibly the second connector contact surface 218 of the connector 212 for carrying the electrical current through the connector 212 and the brush 202. In some embodiments, motion of the brush 202 with respect to the connector 212 can be constrained by a housing 220 and/or one or more other support structures for controlling the motion of the brush 202 with respect to the connector 212. In some embodiments, the housing 220 can be used as the biasing mechanism, e.g., forcing the contact surface(s) of the brush 202 into contact with the connector contact surface(s) of the connector 212 (e.g., without the use of a spring).

As described, the charging contact assembly 200 includes one or more biasing mechanisms (e.g., one or more springs 222) for biasing the connector contact surface 216 (and possibly the second connector contact surface 218) of the connector 212 into contact with the second contact surface 208 (and possibly the third contact surface 210) of the brush 202. For example, one or more first springs 222 are disposed between the connector contact surface 216 and the housing 220 (e.g., brush holder that is coupled to the housing 220 or similar structure thereof), and one or more second springs 222 are disposed between the second connector contact surface 218 and the housing 220 (e.g., brush holder that is coupled to the housing 220 or similar structure thereof). In this manner, the connector contact surface(s) can be biased (e.g., spring-loaded) to apply constant static pressure between the brush 202 and curved plates of the connector 212. In some embodiments, the copper contact connection plates of the connector 212 can have a shunt (not shown) soldered thereto, providing continuity to an electrical device (e.g., a power source, such as AC mains, a battery, etc.). With the shuntless brush arrangement described herein, only the brush 202 moves with each cycle, while the shunt remains static, which can reduce or eliminate the fatigue on the shunt. In some embodiments, a charging contact assembly 200 may include only a single spring-biased connector 212 for each brush 202.

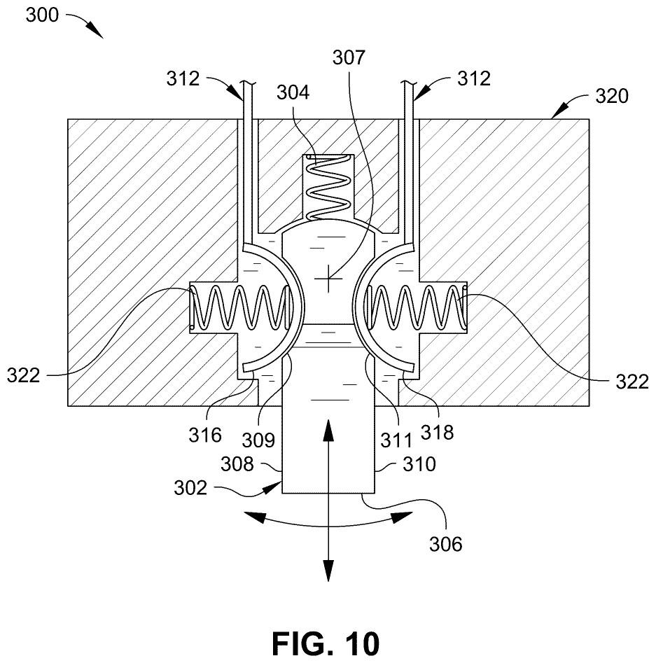

Referring now to FIG. 10, charging contact assemblies 300 are described in accordance with example embodiments of the present disclosure. A charging contact assembly 300 includes a brush 302 for contacting a conducting surface to establish an electrical connection for carrying an electrical current through the conducting surface and the brush 302. In some embodiments, the brush 302 is made from a conducting material such as copper graphite, beryllium copper, etc. The conductive surface is configured to translate with respect to the charging contact assembly 300 (e.g., in a horizontal direction). As described, the brush 302 is configured to translate in another direction, i.e., generally perpendicular to the relative travel direction between the conductive surface and the charging contact assembly 300 (e.g., in a vertical direction). In some embodiments, the brush 302 can be biased in a direction toward the conducting surface, e.g., by one or more springs (e.g., coil springs 304) or other biasing members. In some embodiments, the brush 302 is configured to pivot about an axis 307 that extends generally parallel to the relative travel direction between the charging contact assembly 300 and the conducting surface (e.g, in the horizontal direction).

The brush 302 has a first contact surface 306 for contacting a conducting surface (e.g., the contact of a battery-powered vehicle or another contact) to carry the electrical current through the conducting surface and the brush 302. Rather than relying on a shunt or wire, such as the shunt or wire 52 described with reference to FIGS. 1 and 2, the brush 302 does not have a shunt or wire. Instead, the brush 302 has a second contact surface 308 arranged along a plane generally parallel to the direction of translation of the brush 302 with respect to the conducting surface and generally parallel to the relative travel direction between the charging contact assembly 300 and the conducting surface. In some embodiments, the brush 302 may also have one or more additional contact surfaces. For example, the brush 302 can have a third contact surface 310 opposite from the second contact surface 308 and arranged along another plane generally parallel to the direction of translation of the brush 302 with respect to the conducting surface and generally parallel to the travel direction of the charging contact assembly 300 with respect to the conducting surface.

The charging contact assembly 300 also includes a connector 312 to connect to an electrical device (e.g., a power source, such as AC mains, a battery, etc.) for receiving or delivering electrical current and conducting the electrical current to and/or from the brush 302. For instance, the connector 312 includes one or more connections (not shown) for connecting to the source of electrical energy and a connector contact surface 316 electrically coupled with the connection. As described, the connector contact surface 316 is configured to slidingly contact the second contact surface 308 of the brush 302. In some embodiments, a second connector contact surface 318 of another connector 312 is configured to slidingly contact the third contact surface 310.

As described, the connector contact surface 316 and/or connector contact surface 318 of connector(s) 312 can include curved contact surfaces. Further, the second contact surface 308 of the brush 302 may include a curved concave contact region 309 configured to slidably mate with the curved connector contact surface 316 of the connector 312. In some embodiments, the third contact surface 310 may also include a curved concave contact region 311 configured to slidably mate with the curved connector contact surface 318 of the connector 312. In embodiments of the disclosure, the second contact surface 308 (and possibly the third contact surface 310) of the brush 302 are smooth, conducting side surfaces that mate with the corresponding connector contact surface(s) 316 and/or 318 on the side(s) of the brush 302.

The second contact surface 308 and possibly the third contact surface 310 of the brush 302 slidingly contact the connector contact surface 316 and possibly the second connector contact surface 318 of the connector 312 for carrying the electrical current through the connector 312 and the brush 302. In some embodiments, motion of the brush 302 with respect to the connector 312 can be constrained by a housing 320 and/or one or more other support structures for controlling the motion of the brush 302 with respect to the connector 312. In some embodiments, the housing 320 can be used as the biasing mechanism, e.g., forcing the contact surface(s) of the brush 302 into contact with the connector contact surface(s) of the connector 312 (e.g., without the use of a spring).

As described, the charging contact assembly 300 includes one or more biasing mechanisms (e.g., one or more springs 322) for biasing the connector contact surface 316 (and possibly the second connector contact surface 318) of the connector 312 into contact with the second contact surface 308 (and possibly the third contact surface 310) of the brush 302. For example, one or more first springs 322 are disposed between the connector contact surface 316 and the housing 320 (e.g., brush holder that is coupled to the housing 320 or similar structure thereof), and one or more second springs are disposed between the second connector contact surface 318 and the housing 320 (e.g., brush holder that is coupled to the housing 320 or similar structure thereof). In this manner, the connector contact surface(s) can be biased (e.g., spring-loaded) to apply constant static pressure between the brush 302 and curved plates of the connector 312. In some embodiments, the copper contact connection plates of a connector 312 can have a shunt (not shown) soldered thereto, providing continuity to an electrical device (e.g., a power source, such as AC mains, a battery, etc.). With the shuntless brush arrangement described herein, only the brush 302 moves with each cycle, while the shunt remains static, which can reduce or eliminate the fatigue on the shunt. In some embodiments, a charging contact assembly 300 may include only a single spring-biased connector 312 for each brush 302.

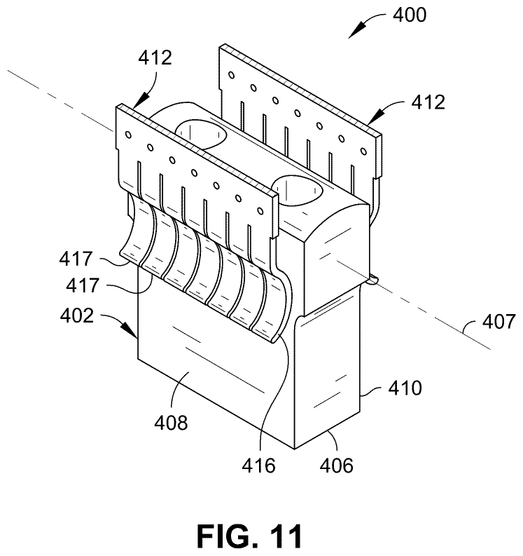

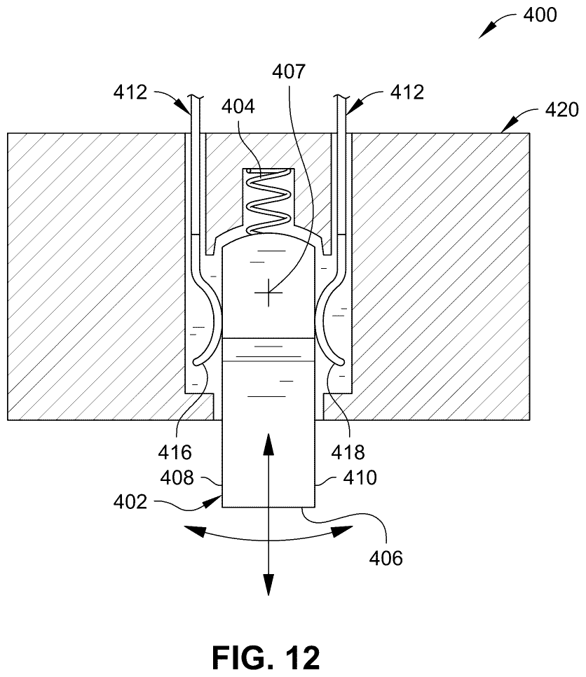

Referring now to FIGS. 11 and 12, charging contact assemblies 400 are described in accordance with example embodiments of the present disclosure. A charging contact assembly 400 includes a brush 402 for contacting a conducting surface to establish an electrical connection for carrying an electrical current through the conducting surface and the brush 402. In some embodiments, the brush 402 is made from a conducting material such as copper graphite, beryllium copper, etc. The conductive surface is configured to translate with respect to the charging contact assembly 400 (e.g., in a horizontal direction). As described, the brush 402 is configured to translate in another direction, i.e., generally perpendicular to the relative travel direction between the conductive surface and the charging contact assembly 400 (e.g., in a vertical direction). In some embodiments, the brush 402 can be biased in a direction toward the conducting surface, e.g., by one or more springs (e.g., coil springs 404) or other biasing members. In some embodiments, the brush 402 is configured to pivot about an axis 407 that extends generally parallel to the relative travel direction between the charging contact assembly 400 and the conducting surface (e.g, in the horizontal direction).

The brush 402 has a first contact surface 406 for contacting a conducting surface (e.g., the contact of a battery-powered vehicle or another contact) to carry the electrical current through the conducting surface and the brush 402. Rather than relying on a shunt or wire, such as the shunt or wire 52 described with reference to FIGS. 1 and 2, the brush 402 does not have a shunt or wire. Instead, the brush 402 has a second contact surface 408 arranged along a plane generally parallel to the direction of translation of the brush 402 with respect to the conducting surface and generally parallel to the relative travel direction between the charging contact assembly 400 and the conducting surface. In some embodiments, the brush 402 may also have one or more additional contact surfaces. For example, the brush 402 can have a third contact surface 410 opposite from the second contact surface 408 and arranged along another plane generally parallel to the direction of translation of the brush 402 with respect to the conducting surface and generally parallel to the travel direction of the charging contact assembly 400 with respect to the conducting surface.

The charging contact assembly 400 also includes a connector 412 to connect to an electrical device (e.g., a power source, such as AC mains, a battery, etc.) for receiving or delivering electrical current and conducting the electrical current to and/or from the brush 402. For instance, the connector 412 includes one or more connections for connecting to the source of electrical energy and a connector contact surface 416 electrically coupled with the connection. The connector contact surface 416 (and possibly a second connector contact surface 418 of another connector) is configured to slidingly contact the second contact surface 408 of the brush 402 (and possibly the third contact surface 410 of the brush 402). As described, the connector 412 has multiple fingers 417 that extend from a base portion of the connector 412 and contact the second surface 408 and/or third contact surface 410 of the brush 402. In embodiments, the connector contact surfaces 416 and/or 418 can be curved contact surfaces, such that the contact between the connector contact surfaces 416 and/or 418 and the respective contact surfaces 408 and/or 410 on the brush 402 form lines of contact. In embodiments of the disclosure, the second contact surface 408 (and possibly the third contact surface 410) of the brush 402 are smooth, conducting side surfaces, and the connector contact surface 416 (and possibly the second connector contact surface 418) includes at least a curved portion of a conducting plate (e.g., a copper plate) on either side of the brush 402.

The second contact surface 408 and possibly the third contact surface 410 of the brush 402 slidingly contact the connector contact surface 416 and possibly the second connector contact surface 418 of the connector 412 for carrying the electrical current through the connector 412 and the brush 402. In some embodiments, motion of the brush 402 with respect to the connector 412 can be constrained by a housing 420 and/or one or more other support structures for controlling the motion of the brush 402 with respect to the connector 412. In some embodiments, the housing 420 can be used as the biasing mechanism, e.g., forcing the contact surface(s) of the brush 402 into contact with the connector contact surface(s) of the connector 412 (e.g., without the use of a spring).

As described, the plurality of fingers 417 are resilient members resistant to deformation such that, when positioned against the brush 402, are placed under elastic tension against the second contact surface 408 and/or the third contact surface 410. In this manner, the connector contact surface(s) associated with the plurality of fingers 417 can be biased (e.g., spring-loaded through elastic tension) to apply constant static pressure between the brush 402 and curved plates of the connector 412. In some embodiments, the copper contact connection plates of the connector 412 can have a shunt (not shown) soldered thereto, providing continuity to an electrical device (e.g., a power source, such as AC mains, a battery, etc.). With the shuntless brush arrangement described herein, only the brush 402 moves with each cycle, while the shunt remains static, which can reduce or eliminate the fatigue on the shunt. In some embodiments, a charging contact assembly 400 may include only a single connector 412 for each brush 402.

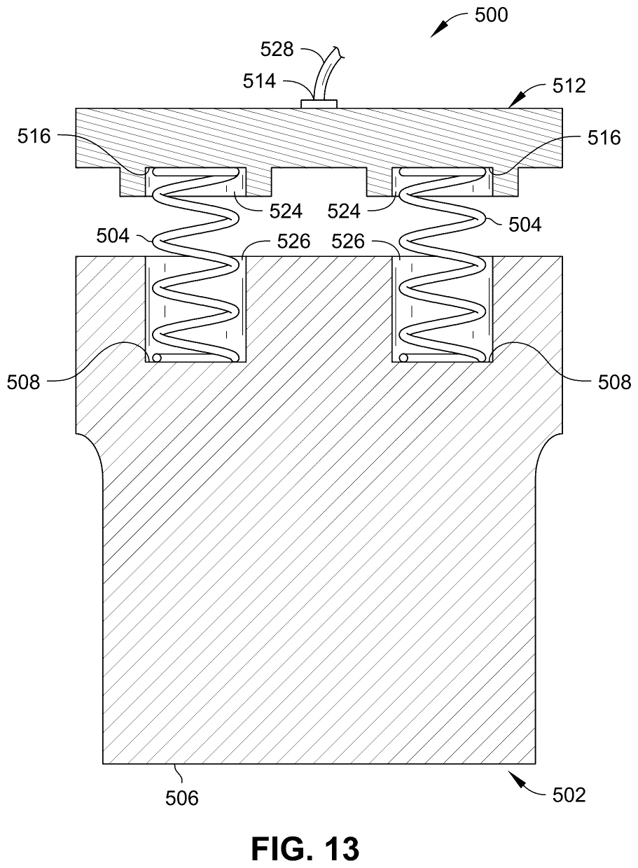

Referring now to FIG. 13, charging contact assemblies 500 are described in accordance with example embodiments of the present disclosure. A charging contact assembly 500 includes a brush 502 for contacting a conducting surface to establish an electrical connection for carrying an electrical current through the conducting surface and the brush 502. In some embodiments, the brush 502 is made from a conducting material such as copper graphite, beryllium copper, etc. The conductive surface is configured to translate with respect to the charging contact assembly 500 (e.g., in a horizontal direction). As described, the brush 502 is configured to translate in another direction, i.e., generally perpendicular to the relative travel direction between the conductive surface and the charging contact assembly 500 (e.g., in a vertical direction). In some embodiments, the brush 502 can be biased in a direction toward the conducting surface, e.g., by one or more springs (e.g., coil springs 504) or other biasing members, including, but not necessarily limited to: compression springs, leaf springs, and so forth.

The brush 502 has a first contact surface 506 for contacting a conducting surface (e.g., the contact of a battery-powered vehicle or another contact) to carry the electrical current through the conducting surface and the brush 502. Rather than relying on a shunt or wire, such as the shunt or wire 52 described with reference to FIGS. 1 and 2, the brush 502 does not have a shunt or wire. Instead, the brush 502 has a second contact surface 508 arranged opposite from the first contact surface 506 and generally perpendicular to the direction of translation of the brush 502 and generally parallel to the relative travel direction between the charging contact assembly 500 and the conducting surface.

The charging contact assembly 500 also includes a connector 512 to connect to an electrical device (e.g., a power source, such as AC mains, a battery, etc.) for receiving or delivering electrical current and conducting the electrical current to and/or from the brush 502. For instance, the connector 512 includes one or more connections 514 for connecting to the source of electrical energy and a connector contact surface 516 electrically coupled with the connection 514. As described, the connector contact surface 516 is arranged generally parallel to the second contact surface 508 of the brush 502. A biasing mechanism, such as the coil springs 504, biases the second contact surface 508 of the brush 502 away from the connector contact surface 516 of the connector 512. As described, the biasing mechanism may be formed of a high strength, high conductivity material that is in electrical contact with both the connector contact surface 516 of the connector 512 and the second contact surface 508 of the brush for conducting an electrical current through the connector 512 to the brush 502 through the biasing mechanism. In general, the connector and the brush may have respective recess holes for retaining corresponding ends of a coil spring used to bias the brush and/or conduct current between the connector and the brush. For example, connector 512 has a recess hole 524 that receives an end of coil spring 504, and brush 502 has a recess hole 526 that receives another end of the coil spring 504.

In some embodiments, motion of the brush 502 with respect to the connector 512 can be constrained by a housing (not shown) and/or one or more other support structures for controlling the motion of the brush 502 with respect to the connector 512. In some embodiments, the copper contact connection plates of the connector 512 can have a shunt 528 soldered thereto, providing continuity to an electrical device (e.g., a power source, such as AC mains, a battery, etc.). With the shuntless brush arrangement described herein, only the brush 502 moves with each cycle, while the shunt remains static, which can reduce or eliminate the fatigue on the shunt. In some embodiments, a charging contact assembly 500 may include only a single spring-biased connector 512 for each brush 502.

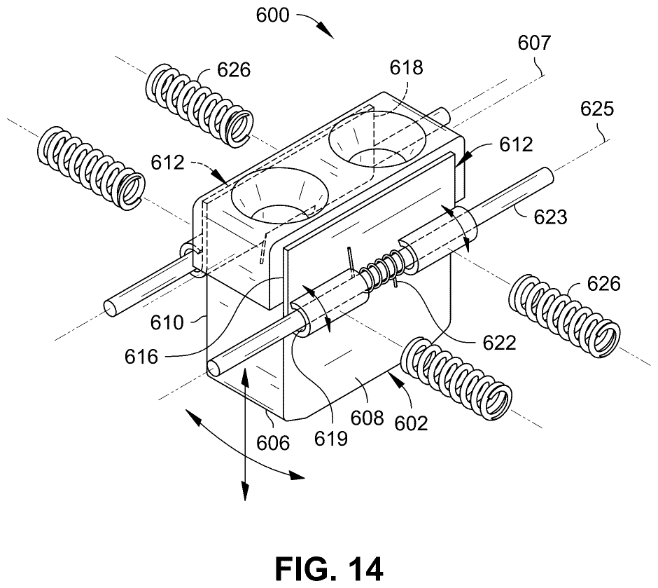

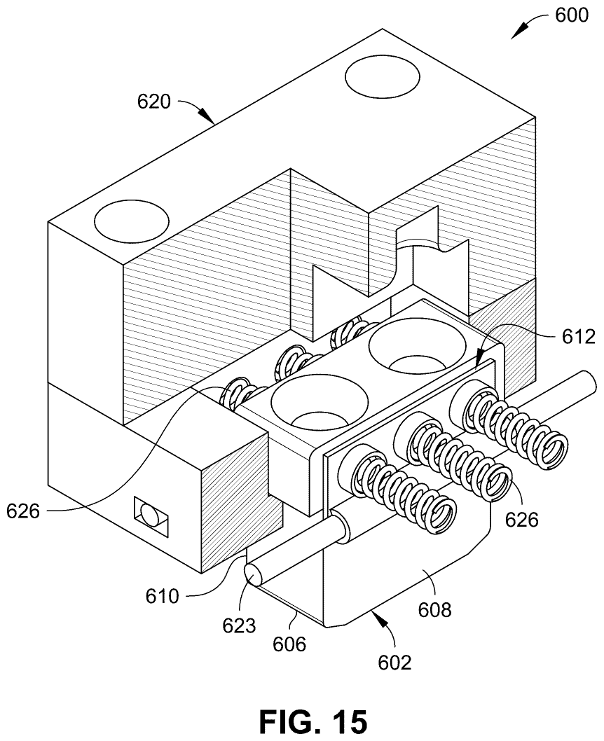

Referring now to FIGS. 14 and 15, charging contact assemblies 600 are described in accordance with example embodiments of the present disclosure. A charging contact assembly 600 includes a brush 602 for contacting a conducting surface to establish an electrical connection for carrying an electrical current through the conducting surface and the brush 602. In some embodiments, the brush 602 is made from a conducting material such as copper graphite, beryllium copper, etc. The conductive surface is configured to translate with respect to the charging contact assembly 600 (e.g., in a horizontal direction). As described, the brush 602 is configured to translate in another direction, i.e., generally perpendicular to the relative travel direction between the conductive surface and the charging contact assembly 600 (e.g., in a vertical direction). In some embodiments, the brush 602 can be biased in a direction toward the conducting surface, e.g., by one or more springs (not shown) or other biasing members. In some embodiments, the brush 602 is configured to pivot about an axis 607 that extends generally parallel to the relative travel direction between the charging contact assembly 600 and the conducting surface (e.g, in the horizontal direction).

The brush 602 has a first contact surface 606 for contacting a conducting surface (e.g., the contact of a battery-powered vehicle or another contact) to carry the electrical current through the conducting surface and the brush 602. Rather than relying on a shunt or wire, such as the shunt or wire 52 described with reference to FIGS. 1 and 2, the brush 602 does not have a shunt or wire. Instead, the brush 602 has a second contact surface 608 arranged along a plane generally parallel to the direction of translation of the brush 602 with respect to the conducting surface and generally parallel to the relative travel direction between the charging contact assembly 600 and the conducting surface. In some embodiments, the brush 602 may also have one or more additional contact surfaces. For example, the brush 602 can have a third contact surface 610 opposite from the second contact surface 608 and arranged along another plane generally parallel to the direction of translation of the brush 602 with respect to the conducting surface and generally parallel to the travel direction of the charging contact assembly 600 with respect to the conducting surface.

The charging contact assembly 600 also includes a connector 612 to connect to an electrical device (e.g., a power source, such as AC mains, a battery, etc.) for receiving or delivering electrical current and conducting the electrical current to and/or from the brush 602. For instance, the connector 612 includes one or more connections (not shown) for connecting to the source of electrical energy and a connector contact surface 616 electrically coupled with a connection. The connector contact surface 616 (and possibly a second connector contact surface 618 of another connector) is configured to slidingly contact the second contact surface 608 of the brush 602 (and possibly the third contact surface 610 of the brush 602). In embodiments, the connector contact surfaces 616 and/or 618 can be a curved or a planar contact surface, such that the contact between the connector contact surfaces 616 and/or 618 and the respective contact surfaces 608 and/or 610 on the brush 602 form a line or lines of contact (and possibly an area of contact). In embodiments of the disclosure, the second contact surface 608 (and possibly the third contact surface 610) of the brush 602 are smooth, conducting side surfaces, and the connector contact surface 616 (and possibly the second connector contact surface 618 of another connecter 612) are conducting plates (e.g., copper plates) on either side of the brush 602.

The second contact surface 608 and possibly the third contact surface 610 of the brush 602 slidingly contact the connector contact surface 616 and possibly the second connector contact surface 618 of the connector(s) 612 for carrying the electrical current through the connector(s) 612 and the brush 602. In some embodiments, motion of the brush 602 with respect to a connector 612 can be constrained by a housing 620 and/or one or more other support structures for controlling the motion of the brush 602 with respect to the connector 612. In some embodiments, the housing 620 can be used as the biasing mechanism, e.g., forcing the contact surface(s) of the brush 602 into contact with the connector contact surface(s) of the connector 612 (e.g., without the use of a spring).

As described, the connector 612 defines a hole 619 that passes parallel to the second contact surface 608 and is configured to receive a conductive pin 623 that has a corresponding axis 625 that passes longitudinally through the conductive pin 623 and about which the connector 612 is permitted to pivot. In some embodiments, a connector 612 includes one or more biasing mechanisms (e.g., one or more springs 622) for biasing the connector contact surface 616 (and possibly a second connector contact surface 618) of the connector 612 into contact with the second contact surface 608 (and possibly the third contact surface 610) of the brush 602. For example, in reference to FIG. 14, one or more first springs 622 can be a torsion spring disposed around the conductive pin 623 that biases the connector 612 towards the brush 602. In this manner, the connector contact surface(s) can be biased (e.g., spring-loaded) to apply constant static pressure between the brush 602 and plates of the connector 612. In some embodiments, the conductive pin 623 can have a shunt (not shown) soldered thereto, providing continuity to an electrical device (e.g., a power source, such as AC mains, a battery, etc.). With the shuntless brush arrangement described herein, only the brush 602 moves with each cycle, while the shunt remains static, which can reduce or eliminate the fatigue on the shunt.

In some embodiments, the charging contact assembly 600 includes one or more biasing mechanisms (e.g., one or more springs 626) for biasing the conductive pin 623 and the connector 612 towards the brush 602. For example, one or more springs 626 are disposed between the connector 612 and a housing to apply constant static pressure between the brush 602 and the connector 612. In some embodiments, only the springs 626 are used to bias the connector 612 towards the brush 602. For example, in reference to FIG. 15, charging contact assembly 600 has springs 626 positioned between the connector 612 and the housing 620 to apply constant static pressure between the brush 602 and the connector 612. In some embodiments, charging contact assembly 600 includes only a single spring-biased connector 612 for each brush 602.

In a first aspect, a charging contact assembly can include a brush for contacting a conducting surface to carry an electrical current from a source of electrical energy through the brush and the conducting surface, where the brush is configured to translate in a first direction at least substantially perpendicular to a second direction of travel of the charging contact assembly with respect to the conducting surface. The brush can include a first contact surface for contacting the conducting surface, and a second contact surface arranged along a plane at least substantially parallel to the first direction of translation of the brush and at least substantially parallel to the second direction of travel of the charging contact assembly with respect to the conducting surface. The charging contact assembly can also include a connector to connect to the source of electrical energy for receiving the electrical current and conducting the electrical current to the brush. The connector can include a connection for connecting to the source of electrical energy, and a connector contact surface electrically coupled with the connection and arranged at least substantially parallel to the second contact surface of the brush to slidingly contact the second contact surface of the brush. The charging contact assembly can further include a biasing mechanism for biasing the connector contact surface of the connector into contact with the second contact surface of the brush.

In some aspects, the biasing mechanism can be at least one spring. In some aspects, the brush can have a third contact surface opposite the second contact surface and arranged along a second plane at least substantially parallel to the first direction of translation of the brush and at least substantially parallel to the second direction of travel of the charging contact assembly with respect to the conducting surface. In some aspects, the connector can have a second connector contact surface electrically coupled with the connection and arranged at least substantially parallel to the third contact surface of the brush to slidingly contact the third contact surface of the brush. In some aspects, the brush can be configured to pivot about an axis extending in a first direction at least substantially parallel to a second direction of travel of the charging contact assembly with respect to the conducting surface. In some aspects, the connector contact surface of the connector can have a curved contact surface. In some aspects, the connector contact surface of the connector can have a flat contact surface pivotally biased into contact with the second contact surface of the brush.

In a second aspect, a charging contact assembly can include a brush for contacting a conducting surface to carry an electrical current from a source of electrical energy through the brush and the conducting surface, where the brush is configured to pivot about an axis extending in a first direction at least substantially parallel to a second direction of travel of the charging contact assembly with respect to the conducting surface. The brush can include a first contact surface for contacting the conducting surface, and a second contact surface arranged at least substantially parallel to the first direction of translation of the brush and at least substantially parallel to the second direction of travel of the charging contact assembly with respect to the conducting surface. The charging contact assembly can also include a connector to connect to the source of electrical energy for receiving the electrical current and conducting the electrical current to the brush. The connector can include a connection for connecting to the source of electrical energy, and a connector contact surface electrically coupled with the connection and arranged at least substantially parallel to the second contact surface of the brush to slidingly contact the second contact surface of the brush. The charging contact assembly can further include a biasing mechanism for biasing the connector contact surface of the connector into contact with the second contact surface of the brush.

In some aspects, the biasing mechanism can be at least one spring. In some aspects, the second contact surface can be arranged along a plane at least substantially parallel to the first direction of translation of the brush and at least substantially parallel to the second direction of travel of the charging contact assembly with respect to the conducting surface. In some aspects, the brush can have a third contact surface opposite the second contact surface and arranged at least substantially parallel to the first direction of translation of the brush and at least substantially parallel to the second direction of travel of the charging contact assembly with respect to the conducting surface. In some aspects, the third contact surface opposite the second contact surface can be arranged along a second plane at least substantially parallel to the first direction of translation of the brush and at least substantially parallel to the second direction of travel of the charging contact assembly with respect to the conducting surface. In some aspects, the connector can have a second connector contact surface electrically coupled with the connection and arranged at least substantially parallel to the third contact surface of the brush to slidingly contact the third contact surface of the brush. In some aspects, the connector contact surface of the connector can have a curved contact surface. In some aspects, the second contact surface of the brush can have a curved contact region configured to slidably mate with the curved contact surface of the connector. In some aspects, the connector contact surface of the connector can have a flat contact surface pivotally biased into contact with the second contact surface of the brush.

In a third aspect, a charging contact assembly can include a brush for contacting a conducting surface to carry an electrical current from a source of electrical energy through the brush and the conducting surface, where the brush is configured to translate in a first direction at least substantially perpendicular to a second direction of travel of the charging contact assembly with respect to the conducting surface. The brush can include a first contact surface for contacting the conducting surface, a second contact surface arranged along a plane at least substantially parallel to the first direction of translation of the brush and at least substantially parallel to the second direction of travel of the charging contact assembly with respect to the conducting surface, and a third contact surface opposite the second contact surface and arranged along a second plane at least substantially parallel to the first direction of translation of the brush and at least substantially parallel to the second direction of travel of the charging contact assembly with respect to the conducting surface. The charging contact assembly can also include a connector to connect to the source of electrical energy for receiving the electrical current and conducting the electrical current to the brush. The connector can include a connection for connecting to the source of electrical energy, a first connector contact surface electrically coupled with the connection and arranged at least substantially parallel to the second contact surface of the brush to slidingly contact the second contact surface of the brush, and a second connector contact surface electrically coupled with the connection and arranged at least substantially parallel to the third contact surface of the brush to slidingly contact the third contact surface of the brush. The charging contact assembly can further include a biasing mechanism for biasing the connector contact surface of the connector into contact with the second contact surface of the brush. In some aspects, the biasing mechanism can be at least one spring. In some aspects, the brush can be configured to pivot about an axis extending in a first direction at least substantially parallel to a second direction of travel of the charging contact assembly with respect to the conducting surface. In some aspects, the connector contact surface of the connector comprises a flat contact surface pivotally biased into contact with the second contact surface of the brush.

In a fourth aspect, a charging contact assembly can include a brush for contacting a conducting surface to carry an electrical current from a source of electrical energy through the brush and the conducting surface, where the brush is configured to translate in a first direction at least substantially perpendicular to a second direction of travel of the charging contact assembly with respect to the conducting surface. The brush can include a first contact surface for contacting the conducting surface, and a second contact surface arranged opposite the first contact surface and at least substantially perpendicular to the first direction of translation of the brush and at least substantially parallel to the second direction of travel of the charging contact assembly with respect to the conducting surface.

The charging contact assembly can also include a connector to connect to the source of electrical energy for receiving the electrical current and conducting the electrical current through the brush. The connector can include a connection for connecting to the source of electrical energy, and a connector contact surface electrically coupled with the connection and arranged at least substantially parallel to the second contact surface of the brush. The charging contact assembly can further include a biasing mechanism for biasing the second contact surface of the brush away from the connector contact surface of the connector, where the biasing mechanism is formed of a high strength, high conductivity material in electrical contact with both the connector contact surface of the connector and the second contact surface of the brush for conducting the electrical current from the connector to the brush through the biasing mechanism. In some aspects, the biasing mechanism can be at least one of a compression spring or a leaf spring. In some aspects, the biasing mechanism can be a beryllium copper material.

It should be noted that while the charging contact assemblies herein have been described with some specificity, this arrangement is provided by way of example and is not meant to limit the present disclosure. In other embodiments, a shuntless brush can be used with other various connectors and/or brush arrangements subject to vibration and/or shock loading. For example, in some embodiments, a shuntless brush is included with a slip ring assembly. In this example, the shuntless brush can be biased into physical contact with a ring rotatably coupled to a holder. In another example, a shuntless brush is used as a motor brush assembly. In this example, the shuntless brush can be biased into contact with a portion of the motor to conduct electrical energy between the rotating and stationary parts of the motor (e.g., by conducting electrical current from the connector, through the shuntless brush, and then to the rotor contacted by the brush). In a further example, a shuntless brush is included with a compact collector or segmented collector shoe assembly, where multiple electrical collectors are movably positioned in a support block in a spaced-apart aligned manner. In this example, one or more shuntless brushes can be connected to a common electrical bus bar attachment.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A charging contact assembly comprising:
a brush for contacting a conducting surface to carry an electrical current from a source of electrical energy through the brush and the conducting surface, the brush configured to translate in a first direction at least substantially perpendicular to a second direction of travel of the charging contact assembly with respect to the conducting surface, the brush including:
a first contact surface for contacting the conducting surface, and
a second contact surface arranged along a plane at least substantially parallel to the first direction of translation of the brush and at least substantially parallel to the second direction of travel of the charging contact assembly with respect to the conducting surface;
a connector to connect to the source of electrical energy for receiving the electrical current and conducting the electrical current to the brush, the connector including:
a connection for connecting to the source of electrical energy, and
a connector contact surface electrically coupled with the connection and arranged at least substantially parallel to the second contact surface of the brush to slidingly contact the second contact surface of the brush; and
a biasing mechanism for biasing the connector contact surface of the connector into contact with the second contact surface of the brush.

2. The charging contact assembly as recited in claim 1, wherein the biasing mechanism comprises at least one spring.

3. The charging contact assembly as recited in claim 1, wherein the brush comprises a third contact surface opposite the second contact surface and arranged along a second plane at least substantially parallel to the first direction of translation of the brush and at least substantially parallel to the second direction of travel of the charging contact assembly with respect to the conducting surface.

4. The charging contact assembly as recited in claim 2, wherein the connector comprises a second connector contact surface electrically coupled with the connection and arranged at least substantially parallel to the third contact surface of the brush to slidingly contact the third contact surface of the brush.

5. The charging contact assembly as recited in claim 1, wherein the brush is configured to pivot about an axis extending in a first direction at least substantially parallel to a second direction of travel of the charging contact assembly with respect to the conducting surface.

6. The charging contact assembly as recited in claim 1, wherein the connector contact surface of the connector comprises a curved contact surface.

7. The charging contact assembly as recited in claim 1, wherein the connector contact surface of the connector comprises a flat contact surface pivotally biased into contact with the second contact surface of the brush.

8. A charging contact assembly comprising:
a brush for contacting a conducting surface to carry an electrical current from a source of electrical energy through the brush and the conducting surface, the brush configured to pivot about an axis extending in a first direction at least substantially parallel to a second direction of travel of the charging contact assembly with respect to the conducting surface, the brush including:
a first contact surface for contacting the conducting surface, and
a second contact surface arranged at least substantially parallel to the first direction of translation of the brush and at least substantially parallel to the second direction of travel of the charging contact assembly with respect to the conducting surface;
a connector to connect to the source of electrical energy for receiving the electrical current and conducting the electrical current to the brush, the connector including:
a connection for connecting to the source of electrical energy, and
a connector contact surface electrically coupled with the connection and arranged at least substantially parallel to the second contact surface of the brush to slidingly contact the second contact surface of the brush; and
a biasing mechanism for biasing the connector contact surface of the connector into contact with the second contact surface of the brush.

9. The charging contact assembly as recited in claim 8, wherein the biasing mechanism comprises at least one spring.

10. The charging contact assembly as recited in claim 8, wherein the second contact surface is arranged along a plane at least substantially parallel to the first direction of translation of the brush and at least substantially parallel to the second direction of travel of the charging contact assembly with respect to the conducting surface.

11. The charging contact assembly as recited in claim 8, wherein the brush comprises a third contact surface opposite the second contact surface and arranged at least substantially parallel to the first direction of translation of the brush and at least substantially parallel to the second direction of travel of the charging contact assembly with respect to the conducting surface.

12. The charging contact assembly as recited in claim 11, wherein the third contact surface opposite the second contact surface is arranged along a second plane at least substantially parallel to the first direction of translation of the brush and at least substantially parallel to the second direction of travel of the charging contact assembly with respect to the conducting surface.

13. The charging contact assembly as recited in claim 11, wherein the connector comprises a second connector contact surface electrically coupled with the connection and arranged at least substantially parallel to the third contact surface of the brush to slidingly contact the third contact surface of the brush.

14. The charging contact assembly as recited in claim 8, wherein the connector contact surface of the connector comprises a curved contact surface.

15. The charging contact assembly as recited in claim 14, wherein the second contact surface of the brush comprises a curved contact region configured to slidably mate with the curved contact surface of the connector.

16. The charging contact assembly as recited in claim 8, wherein the connector contact surface of the connector comprises a flat contact surface pivotally biased into contact with the second contact surface of the brush.

17. A charging contact assembly comprising:
a brush for contacting a conducting surface to carry an electrical current from a source of electrical energy through the brush and the conducting surface, the brush configured to translate in a first direction at least substantially perpendicular to a second direction of travel of the charging contact assembly with respect to the conducting surface, the brush including:
a first contact surface for contacting the conducting surface,
a second contact surface arranged along a plane at least substantially parallel to the first direction of translation of the brush and at least substantially parallel to the second direction of travel of the charging contact assembly with respect to the conducting surface, and
a third contact surface opposite the second contact surface and arranged along a second plane at least substantially parallel to the first direction of translation of the brush and at least substantially parallel to the second direction of travel of the charging contact assembly with respect to the conducting surface; and
a connector to connect to the source of electrical energy for receiving the electrical current and conducting the electrical current to the brush, the connector including:
a connection for connecting to the source of electrical energy,
a first connector contact surface electrically coupled with the connection and arranged at least substantially parallel to the second contact surface of the brush to slidingly contact the second contact surface of the brush, and
a second connector contact surface electrically coupled with the connection and arranged at least substantially parallel to the third contact surface of the brush to slidingly contact the third contact surface of the brush; and
a biasing mechanism for biasing the connector contact surface of the connector into contact with the second contact surface of the brush.

18. The charging contact assembly as recited in claim 1, wherein the biasing mechanism comprises at least one spring.

19. The charging contact assembly as recited in claim 1, wherein the brush is configured to pivot about an axis extending in a first direction at least substantially parallel to a second direction of travel of the charging contact assembly with respect to the conducting surface.

20. The charging contact assembly as recited in claim 1, wherein the connector contact surface of the connector comprises a flat contact surface pivotally biased into contact with the second contact surface of the brush.
